(19) United States
(12) Patent Application Publication
(10) Pub. No.: US 2018/0346043 A1
(43) Pub. Date: Dec. 6, 2018

(54) BLOCKING DEVICE FOR A WIPER LINKAGE MECHANISM, LINKAGE BEARING, LINKAGE SUB-ASSEMBLY AND ASSOCIATED LINKAGES, AND METHOD FOR INSTALLING A BLOCKING DEVICE ON A LINKAGE

(71) Applicant: Valeo Systèmes d'Essuyage, Le Mesnil Saint Denis (FR)

(72) Inventors: Robin Viard, Issoire (FR); Pascal Renoux, Issoire (FR); Nicholas Kuchly, Issoire (FR)

(73) Assignee: Valeo Systèmes d'Essuyage, Le Mesnil Saint Denis (FR)

(21) Appl. No.: 15/996,980

(22) Filed: Jun. 4, 2018

(30) Foreign Application Priority Data
Jun. 5, 2017 (FR) 1754965

(51) Int. Cl. B62D 65/02; B60S 1/24; F16H 21/40

(52) U.S. Cl. CPC B62D 65/022; F16H 21/40; B60S 1/245

(57) ABSTRACT

The present invention concerns a device (1) for retaining a linkage (3) of a wiper mechanism in a transport position, retaining device (1) includes:
a clip comprising two elastic arms intended to cooperate with a bush (31) of the linkage (3), and
a retaining staple intended to cooperate with a link (33) of the linkage (3), the retaining staple being connected to the clip so that in the mounted state the retaining device (1) connects the link (33) to the bush (31) in a fixed manner in a close position of the bush (31) relative to the link (33).

The present invention relates to the field of linkages of wiper mechanisms, in particular for motor vehicles, and more particularly to locking those linkages in a transport position. The present invention relates more specifically to a device for retaining a linkage comprising at least one crank and at least one link in a transport position, to a bearing of a linkage intended to cooperate with the retaining device, to a linkage subassembly and to a linkage including a retaining device of this kind locked in a transport position and to a method of placing that retaining device on the linkage.

Motor vehicle wiper mechanism linkages are systems articulated at various locations. This articulation is necessary for the correct functioning of the wiper system once the linkage has been installed on the motor vehicle. However, this kind of articulation causes problems in particular for transporting this linkage and for installing it on the motor vehicle. Accordingly, it is necessary to limit the degrees of freedom of the linkage both during transport and during installation thereof.

There are known locking elements enabling connection of the link to bearings enabling fixing of the linkage to the motor vehicle so that the linkage is in a transport position. The known prior art locking elements can take various forms, such as a clamp form for example, in order to lock this linkage in a transport and installation position, that is to say in a position in which all movement of a bearing of the linkage relative to the link is prevented.

However, these known locking elements are for single use and are removed by cutting, for example after installation of the linkage on the motor vehicle. Accordingly, it is necessary to use tools, generally cutting tools, in order to be able to release the linkage. Moreover, this kind of locking element produces debris that it will be necessary to process afterwards, which generates additional costs.

An objective of the present invention is to alleviate at least partly the disadvantages of the prior art described above.

Another objective of the present invention, different from the preceding objective, is to propose a locking element of a linkage of a wiper mechanism in particular for motor vehicles that can be removed without necessitating tools.

Another objective of the present invention, different from the preceding objectives, is to propose a locking element that can remain on the linkage of the wiper mechanism once the latter has been installed so as to reduce the production of waste to be processed.

Another objective of the present invention, different from the preceding objectives, is to propose a locking element that is simple to install on a linkage of a wiper mechanism.

A further objective of the present invention, different from the preceding objectives, is to propose a locking element that enables simple release of the linkage of the wiper mechanism.

To this end, in order to achieve at least one of the aforementioned objectives at least partly, the present invention consists in a device for obtaining a linkage of a wiper mechanism in a transport position, including:
a clip comprising two elastic arms intended to cooperate with a bush of the linkage, and
a retaining staple intended to cooperate with a link of the linkage, the retaining staple being connected to the clip so that in the mounted state the retaining device connects the link to the bush in a fixed manner in a close position of the bush relative to the link.

The retaining device locks the linkage in the transport position by locking the position of the link relative to the bush of the linkage. This retaining device is advantageously installed on the link and on the bush by clipping it on. Thus the installation of this retaining device does not necessitate any tools. Moreover, this linkage is released in a simple manner and does not necessitate the use of tools either.

The retaining device may further include one or more of the following features separately or in combination.

The elastic arms each include fixing lugs, in particular at the level of the ends of the elastic arms, said fixing lugs being intended to cooperate with a complementary shape present on the bush.

The retaining staple includes a retaining arm having at its free end a locking member intended to cooperate with the link.

The retaining staple is advantageously in the general shape of a U the bottom of which is intended to hold the link against a crank of the linkage.

One of the branches of the U includes the locking member.

According to one embodiment, the retaining device is made of a plastic material.

The present invention also consists in a bearing of a wiper mechanism comprising, a bush comprising a portion of smaller diameter intended to cooperate with the clip of a retaining device as defined above.

The bearing device may further include one or more of the following features separately or in combination.

The bush comprises at least one first pair of depressions intended to cooperate with fixing lugs carried by the ends of the elastic arms.

The bush includes a first pair of depressions and a second pair of depressions.

Each pair of depressions advantageously comprises chamfers to facilitate the movement of the retaining device.

The first pair of depressions may define an unlocked position of the retaining device.

The second pair of depressions may define a locking position of the retaining device.

The present invention also consists in a linkage subassembly of wiper mechanism, comprising:
a bearing comprising a bush,
a crank articulated to the bearing, having a first end connected to the bearing and a second end carrying a ball joint enabling the articulation of a link,
a link one end of which is connected by the ball joint to the crank, and
a retaining device as defined above.

According to one aspect, the bearing features a bush as defined above cooperating with the clip of the retaining device.

The present invention also consists in a linkage of a wiper mechanism, comprising a first linkage subassembly and a second linkage subassembly connected to one another by a link, the first linkage subassembly and/or the second linkage subassembly is a linkage subassembly as defined above, said first linkage subassembly and/or second linkage subassembly being in particular locked in the transport position of the linkage with the aid of the retaining device.

The locking of the first or second linkage subassembly in the transport position of the linkage with the aid of the retaining device is reversible.

The linkage further comprises a motor connected to at least one crank, said motor being configured to enable the movement in translation of the link via the crank.

According to one embodiment, the motor is installed on a second side of the linkage.

According to one particular embodiment, the linkage features a retaining device disposed on the first or second linkage subassembly in such a manner as to lock each end of the link in the transport position of the linkage.

The present invention also consists in a method of placing a retaining device as defined above on a linkage subassembly as defined above, the placing method comprising at least:
a step of fixing the clip to the bush, and
a step of fixing the retaining staple to the link.

According to a first placement variant, the step of fixing the clip to the bush precedes the step of fixing the retaining staple to the link, the clip being fixed to the bush in a raised mounting position and then moved toward a lowered transport position in such a manner that the retaining staple cooperates with the link so that the position of the link relative to the bush is fixed.

According to a second placement variant, the step of fixing the retaining staple to the link precedes the step of fixing the clip to the bush, the step of fixing the clip to the bush being carried out in a lowered transport position so that the position of the link relative to a bush is fixed.

According to a first linkage release variant, the retaining device releases the linkage by movement of the retaining arm away from the retaining staple and then by movement of the retaining device from a lowered transport position to a raised mounting position.

According to this first release variant, the retaining device remains on the bush after the release of the linkage.

According to a second linkage release variant, the retaining device releases the linkage by moving the elastic arms away from the bush.

According to this second release variant, the retaining device remains on the link after the linkage is released.

According to another variant, the retaining device is removed from the linkage after the latter is released.

The retaining device is installed on the linkage on the driver side or the passenger side.

Other advantages and features of the present invention will become more clearly apparent on reading the following description given by way of nonlimiting illustration and from the appended drawings, in which:

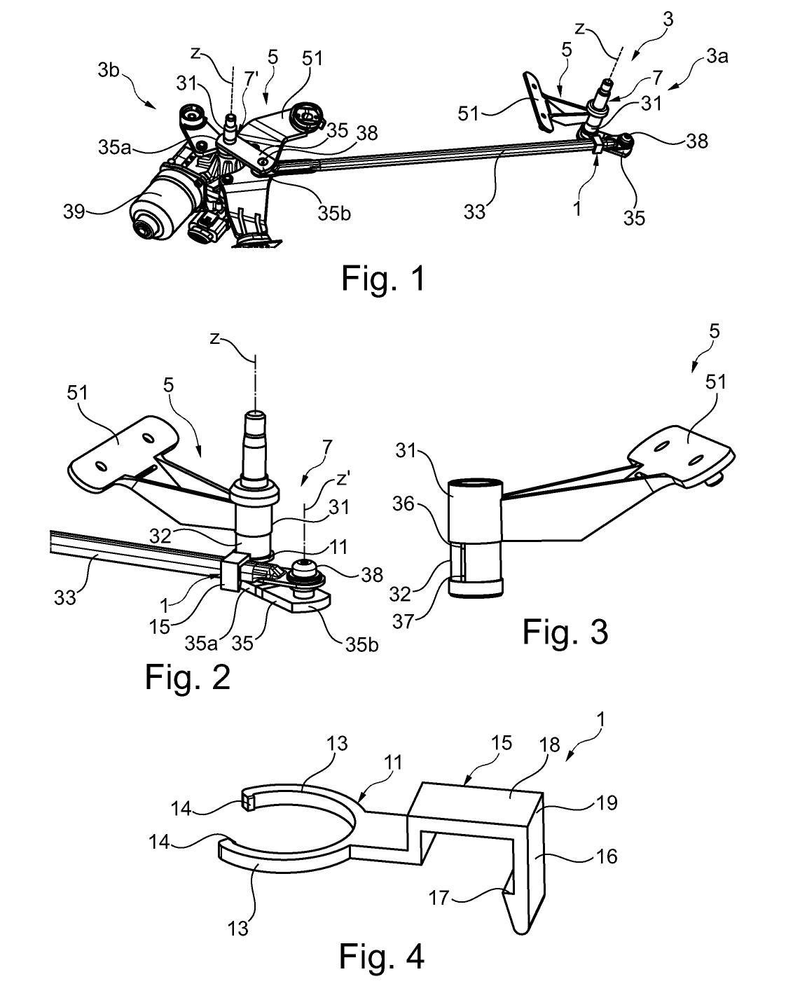

FIG. 1 is a diagrammatic perspective view of a linkage locked in a transport position with the aid of a retaining device according to the present invention,

FIG. 2 is a diagrammatic perspective view of a linkage subassembly locked in the transport position with the aid of the retaining device,

FIG. 3 is a diagrammatic perspective view of a bearing including a bush according to one particular embodiment,

FIG. 4 is a diagrammatic perspective view of the retaining device enabling locking of the linkage from FIG. 1,

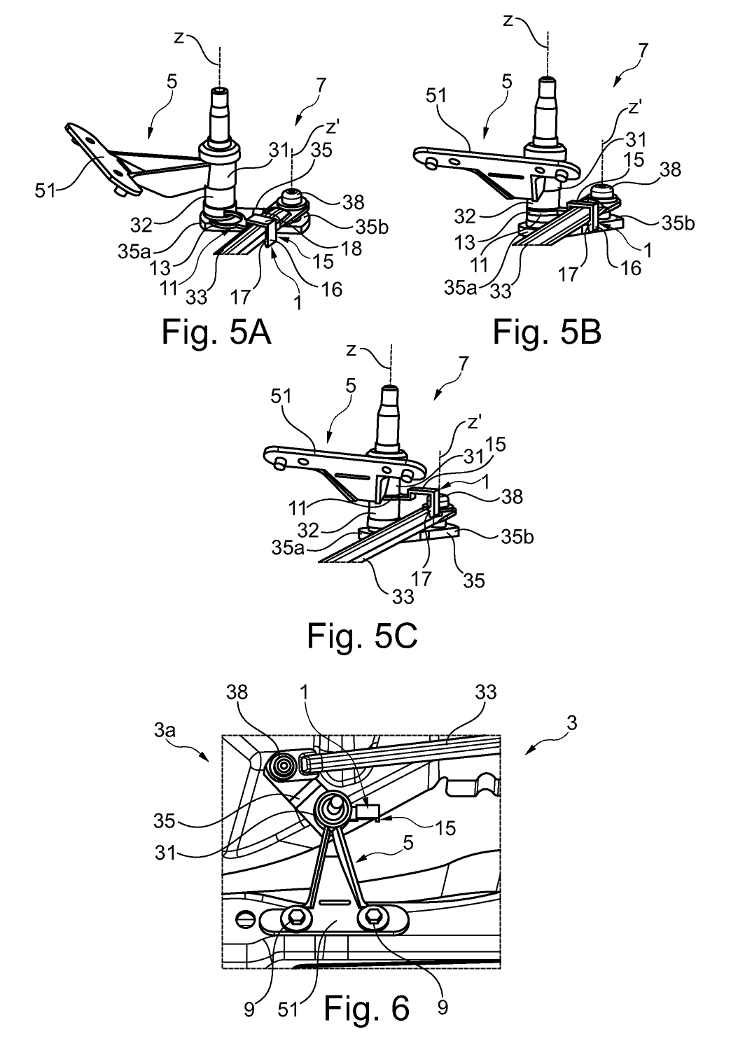

FIG. 5A is a diagrammatic perspective view of a linkage subassembly during a step of locking a link against a bush,

FIG. 5B is a diagrammatic perspective view of the linkage subassembly from FIG. 5A following the locking step,

FIG. 5C is a diagrammatic perspective view of the linkage subassembly from FIG. 5A following a step of releasing the link, and

FIG. 6 is a diagrammatic partial perspective view of the linkage installed on a motor vehicle.

In these figures, identical elements bear the same reference numbers.

The following embodiments are examples. Although the description refers to one or more embodiments, this does not necessarily mean that each reference concerns the same embodiment or that the features apply only to only one embodiment. Single features of different embodiments may equally be combined or interchanged to produce other embodiments.

The following description refers to first and second sides of the linkage, first and second ends of the crank, first and second axes of rotation of the linkage subassembly, first and second pairs of depressions on the bush, and first and second linkage subassemblies. This is merely indexing to differentiate and to designate elements that are close but not identical. This indexing does not imply any priority of one element over another and such designations may easily be interchanged without departing from the scope of the present description. Nor does this indexing imply an order in time, for example to assess the disposition of the linkage on the motor vehicle, its operation, or again its installation.

In the following description, there is meant in particular by “transport position” a position in which at least one end of the link and a crank to which that end of the link is connected form a minimum angle. To be more precise, at least this end of the link is in a position close to the bearing on which the crank is articulated so that the linkage has a minimum overall size when it is in the transport position.

Moreover, in the following description by “mounted state” is meant the mounted state of the retaining device. To be more precise, this corresponds to the locking position of the retaining device, that is to say its position when it locks the linkage in the transport position.

Referring to FIGS. 1 to 4, there is represented a linkage 3 of a wiper mechanism reversibly locked in a transport position. The linkage 3 comprises a first linkage subassembly 7 (seen better in FIG. 2) and a second linkage subassembly 7′ connected to one another by a link 33, and a motor 39 configured to move the link 33 in translation and to drive with an alternating pivoting movement axes (Z) intended to carry wiper arms (not shown). The first linkage subassembly 7 and the second linkage subassembly 7′ are respectively disposed on a first side 3a and a second side 3b of the linkage 3.

The first linkage subassembly 7 and the second linkage subassembly 7′ comprise a bearing 5 comprising a bush 31, a crank 35 articulated on the bush 5, and a retaining device 1 (seen better in FIG. 4). The motor 39 is connected to at least one crank 35 in such a manner as to enable the movement in translation of the link 33 thanks to the movement of this crank 35. The motor 39 is disposed on the second side 3b of the linkage 3. The second side 3b of the linkage 3 generally corresponds to the driver side of a motor vehicle when the linkage 3 is installed on the latter. According to a variant, the second side 3b may correspond to the passenger side of the motor vehicle once the linkage 3 is installed on the latter.

The crank 35 of each of the first linkage subassembly 7 and the second linkage subassembly 7′ has a first end 35a connected to the bearing 5, for example by a pivot connection, and a second end 35b carrying a ball joint 38. The ball joint 38 is connected to one end of the link 33 and enables the articulation of that link 33 in order to enable its movement in translation.

Referring to FIG. 4, the retaining device 1 includes a clip 11 intended to cooperate with the bush 31 and a retaining staple 15 intended to cooperate with the end of the link 33. According to the particular embodiment from FIG. 1, in order to retain the linkage 3 fixed in the transport position, the clip 11 cooperates with the bush 31 in such a manner that the position of the end of the link 33 cooperating with the retaining staple 15 relative to the bush 31 is fixed. Accordingly, the articulation of the link 33 on the ball joint 38 is locked.

The retaining device 1 may be made from a plastic material. The use of this kind of material enables the retaining device 1, and in particular the clip 11 and the retaining staple 15, to deform reversibly.

The clip 11 comprises two elastic arms 13 intended to cooperate with the bush 31 of the linkage 3. According to the particular embodiment from FIG. 4, the elastic arms 13 may each include fixing lugs 14, in particular at the ends of the elastic arms 13. These fixing lugs 14 are intended to cooperate with complementary shapes on the bush 31. This cooperation is described in more detail hereinafter.

Moreover, the retaining staple 15 is intended to cooperate for example with the end of the link 33 connected to the first linkage subassembly 7, according to the embodiment from FIG. 1. The retaining staple 15 is connected to the clip 11 so that in the mounted state the retaining device 1 connects the end of the link 33 in a position close to the bush 31 in such a manner as to hold the link 33 fixed relative to the bush 31, as shown in FIGS. 1 and 2.

According to the particular embodiment from FIG. 4, the retaining staple 15 includes a retaining arm 16 having at its free end a locking member 17 intended to cooperate with the link 33. The presence of the locking member 17 makes it possible to strengthen the cooperation between the link 33 and the retaining staple 15.

Moreover, the retaining staple 15 is in the general shape of a U the bottom 18 of which is intended to hold the link 33 against the crank 35 of the linkage 3. According to this particular embodiment, one of the branches 19 of the U includes the locking member 17. In the present instance, this is the branch 19 that is farther from the clip 11.

Referring to FIG. 2, there is shown in more detail the first linkage subassembly 7 from FIG. 1. The first linkage subassembly 7 includes a first rotation axis Z intended to carry a wiper arm and enabling movement in rotation of the second end 35b of the crank 35 about the bush 31 and a second rotation axis 7′ enabling movement of the end of the link 33 connected to the ball joint 38 relative to the bush 31.

The bush 31 cooperates with the elastic arms 13 of the clip 11 in order to fix the retaining device 1 to the bush 31. According to the particular embodiment from FIGS. 2 and 3, the bush 31 may include a portion 32 of smaller diameter cooperating with the clip 11 of the retaining device 1 in order to limit the movement of the retaining device 1 parallel to the first rotation axis Z.

Referring to FIG. 3, the bush 31 may include complementary shapes cooperating with the fixing lugs 14. These complementary shapes correspond to at least one first pair of depressions 36. According to the particular embodiment from FIG. 3, the bush 31 includes a first pair 36 of depressions and a second pair 37 of depressions respectively defining an unlocked position (here a raised mounting position) and a locking position (here a lowered transport position) in which the relative position of the bush 31 and the link 33 is fixed. The presence in particular of the second pair of depressions 37 makes it possible to prevent rotation of the clip 11 on the bush and therefore makes it possible to stiffen the connection between the link 33 and the bush 31 when the linkage 3 is in its transport position. Moreover, each depression pair 36, 37 may comprise chamfers to facilitate the movement of the retaining device 1 between the locking position and the unlocked position of the retaining device 1 and vice versa.

The presence of the retaining device 1 on the first linkage subassembly 7 makes it possible to prevent all rotation of the crank 35 about the first rotation axis Z and also all rotation of the link 33 about the second rotation axis Z′, thereby locking the first linkage subassembly 7 with a fixed position of the link 33 relative to the bush 31.

According to the particular embodiment from FIG. 1, the linkage 3 includes a single retaining device 1 disposed on the first side 3a of the linkage 3 in order reversibly to lock the first linkage subassembly 7 in the transport position of the linkage 3.

According to another embodiment not shown here, the linkage 3 may include two retaining devices 1, one disposed on the first side 3a of the linkage 3 and the other disposed on the second side 3b of the linkage 3 in order reversibly to lock the movement of each end of the link 33 relative to the bush 31 of the first linkage subassembly 7 and the second linkage subassembly 7′ respectively.

According to another embodiment not shown here, only the second side 3b of the linkage 3 includes the retaining device 1 in order reversibly to lock the second linkage subassembly 7′ in the transport position of the linkage.

The retaining device 1 advantageously enables elimination of degrees of freedom of movement of some parts of the linkage 3, which facilitates transporting it. Moreover, installing this linkage 3 on the motor vehicle is also facilitated thanks to the retaining device 1 that prevents rotation of the various elements of the linkage 3 about the first rotation axis Z and the second rotation axis Z′.

The method for placing the retaining device 1 on the linkage 3 is described in more detail with reference to FIGS. 5A and 5B. The placing of the retaining device 1 on the linkage 3 comprises at least a step a of fixing the clip 11 onto the bush 31 and a step b of fixing the retaining staple 15 to the link 33.

According to the particular embodiment from FIGS. 5A and 5B, the step b of fixing the retaining staple 15 to the link 33 precedes the step a of fixing the clip 11 to the bush 31. The step a of fixing the clip 11 to the bush 31 is then carried out in the locking position so that the position of the link 33 relative to the bush 31 is fixed. To be more precise, during the step a of fixing the clip 11 onto the bush 31, the link 33 provided with the retaining device 1 is turned so that the elastic arms 13 cooperate with the portion 32 of smaller diameter of the bush 31. During this step a, the fixing lugs 14 cooperate with the second pair of depressions 37 carried by the bush 31 in such a manner as to maintain the position of the link 33 relative to the bush 31.

According to a variant not shown here, the step a of fixing the clip 11 onto the bush 31 may precede the step b of fixing the retaining staple 15 to the link 33, the clip 11 initially being fixed to the bush 31 at the level of the first pair of depressions 36, thus defining an unlocked position. The link 33 is then moved toward the bush 31 and finally the clip 11 is moved toward its locking position in order to cooperate with the second pair of depressions 37 in such a manner that the retaining staple 15 cooperates with the link 33 so that the position of the link 33 relative to the bush 31 is fixed.

Accordingly, whatever the order of the steps a, b for fixing the retaining device 1, the use of tools is not necessary. In fact, the clip 11 and the retaining staple 15 enable the retaining device 1 to be installed easily on the linkage 3 simply by clipping it on. Moreover, this kind of retaining device 1 may be used to retain a linkage 3 in the transport position having a link 33 that is either solid or has a U-section.

Referring to FIGS. 5B and 5C, there is represented a method of releasing the link 33. This release method is advantageously carried out after installation of the linkage 3 on the motor vehicle as shown in more detail in FIG. 6.

As described above, with reference to FIG. 5B, the linkage 3 is in the transport position. According to the particular embodiment from FIGS. 5B and 5C, the linkage 3 is released by moving the retaining arm 16 away from the retaining staple 15 and then by movement of the retaining device 1 from its locking position to its unlocked position. To be more precise, the retaining arm 16 is moved away by pulling the branch 19 of the U forming the retaining staple 15 in a direction away from the clip 11 so as to widen the spacing of the branches of the U. To be more precise, the movement away of the retaining arm 16 makes it possible to widen the spacing of the branches of the U so that the locking member 17 is no longer in contact with the link 33. The retaining device 1, and to be more precise the clip 11, is then moved by sliding it inside the portion 32 of the bush 31. More particularly, the fixing lugs 14 of the elastic arms 13 exit the second pair of depressions 37 to cooperate with the first pair of depressions 36 at the end of the movement of the clip 11, as described with reference to FIG. 5C. Once the retaining device 1 has been moved to its unlocked position, the link 33 and the crank 35 are again mobile about the first rotation axis Z and the second rotation axis Z′.

According to another embodiment not shown here, the retaining device 1 may release the linkage by moving apart the elastic arms 13 of the bush 31. This moving apart of the elastic arms 13 of the bush 31 makes it possible to remove the clip 11 of the retaining device 1 from the bush 31 and thus to release the link 33.

Accordingly, releasing the linkage 3, possibly after its installation on the vehicle, does not necessitate the use of tools and can be carried out easily and in a simple manner.

Referring to FIG. 6, there is partly shown the linkage 3 installed on the motor vehicle with the aid of fixing screws 9 configured to fasten the bearing 5, and in particular a plate 51 carried by that bearing 5, to an element of the motor vehicle. According to this embodiment, the link 33 is free to be moved in translation by the motor 39 (shown in FIG. 1). More particularly, FIG. 6 corresponds to the first side 3a of the linkage 3. According to the particular embodiment from FIG. 6, the link 33 is released by the release method described with reference to FIGS. 5B and 5C. The retaining device 1 may advantageously remain on the bush 31 in its unlocked position. The fact that the retaining device 1 remains on the bush 31 does not degrade the operation of the linkage 3 because the link 33 does not pass through its transport position during its to and fro movements during wiping.

According to another embodiment not shown here, the retaining device 1 may remain on the link 33 after the linkage 3 is released.

The fact of leaving the retaining device 1 on the linkage 3 advantageously enables the latter to be reused if necessary in order to lock the linkage in its transport position again. Moreover, the possibility of leaving the retaining device 1 on the linkage 3 after installation thereof makes it possible to limit the quantity of waste to be processed.

The various embodiments given here are described only by way of nonlimiting illustration. In fact, it is entirely possible for the person skilled in the art to use the retaining device 1 with a bush 31 having no portion 32 of smaller diameter without departing from the context of the present invention. Moreover, the person skilled in the art could entirely remove the retaining device 1 from the linkage 3 after its installation on the motor vehicle without departing from the context of the present invention. Moreover, the person skilled in the art could use any material other than a plastic material to form the retaining device 1 without departing from the context of the present description, the use of a plastic material for the retaining device 1 relating only to a preferred embodiment.

Accordingly, the reversible retention of a linkage 3 in a transport position is possible thanks to the retaining device 1 described above. The retaining device 1 is advantageously installed on the linkage 3 without necessitating tools and releasing the linkage 3 is also possible without using tools. Moreover, the use of this kind of retaining device 1 makes it possible to limit the waste to be processed because it remains on the linkage 3 following its installation on the motor vehicle.

1. A device for retaining a linkage of a wiper mechanism in a transport position, the retaining device comprising:
a clip comprising two elastic arms that cooperate with a bush of the linkage; and
a retaining staple that cooperates with a link of the linkage, the retaining staple being connected to the clip so that in the mounted state the retaining device connects the link to the bush in a fixed manner in a close position of the bush relative to the link.

2. The retaining device according to claim 1, wherein elastic arms each include fixing lugs at the level of the ends of the elastic arms, wherein the fixing lugs cooperate with a complementary shape present on the bush.

3. The retaining device according to claim 1, wherein the retaining staple includes a retaining arm having at a free end a locking member that cooperates with the link.

4. The retaining device according to claim 3, wherein retaining staple is in a U-shape, the bottom of which holds the link against a crank of the linkage.

5. The retaining device according to claim 4, wherein one of the branches of the U-shape includes the locking member.

6. A bearing of a wiper mechanism comprising a bush, wherein the bush comprises a portion of smaller diameter that cooperates with the clip of a retaining device according to claim 2.

7. The bearing according to claim 6, wherein the bush comprises at least one first pair of depressions that cooperate with fixing lugs carried by the ends of the elastic arms.

8. The bearing according to claim 7, wherein the bush includes a first pair of depressions and a second pair of depressions.

9. The bearing according to claim 8, wherein each pair of depressions comprises chamfers to facilitate the movement of the retaining device.

10. A linkage subassembly of a wiper mechanism, comprising:
a bearing comprising a bush;
a crank articulated to the bearing, having a first end connected to the bearing and a second end carrying a ball joint enabling the articulation of a link ;
a link one end of which is connected by the ball joint to the crank; and
a retaining device according to claim 1.

11. The linkage subassembly according to claim 10, wherein the at least one bearing includes a bush comprising a portion of smaller diameter cooperating with the clip of the retaining device.

12. A linkage of a wiper mechanism, comprising:
a first linkage subassembly; and
a second linkage subassembly connected to the first linkage subassembly by a link,
wherein the first linkage subassembly and/or the second linkage subassembly is a linkage subassembly according to claim l0,
said first linkage subassembly and/or second linkage subassembly being locked in the transport position of the linkage with the aid of the retaining device.

13. A method of placing a retaining device in accordance with claim 1 on a linkage subassembly comprising a bearing having a bush, a crank articulated to the bearing having a first end connected to the bearing and a second end carrying a ball joint enabling the articulation of a link, and a link one end of which is connected by the ball joint to the crank and the retaining device, the method comprising:
a step (a) of fixing the clip to the bush; and
a step (b) of fixing the retaining staple to the link.
